(19) United States
(12) Patent Application Publication
(10) Pub. No.: US 2006/0281425 A1
(43) Pub. Date: Dec. 14, 2006

(54) Feed forward spur reduction in mixed signal system

(76) Inventor: Roger Lee Jungerman, Petaluma, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/148,048

(22) Filed: Jun. 8, 2005

(51) Int. Cl. H04B 1/18

(52) U.S. Cl. 455/183.2; 455/183.1

(57) ABSTRACT

A mixed-signal system is capable of reducing spurious signals in data signals by estimating the amplitude and phase of a spur cancellation signal. The mixed-signal system includes a processor connected to receive a converted test signal including one or more spurious signals. The converted test signal corresponds to an analog or digital test signal converted between the analog domain and the digital domain. The processor determines the amplitude and estimates the phase of the spur cancellation signal from the converted test signal. The spur cancellation signal can be used to reduce the one or more spurious signals in a data signal.

### BACKGROUND OF THE INVENTION

As integrated circuits continue to reach higher levels of performance through shrinking feature sizes, greater integration and higher clock frequencies, manufacturers of integrated circuit devices have struggled to improve performance while also scaling the cost with the technology. Mixed-signal integrated circuit devices have the additional burden of digital noise in the analog signals. Although great efforts are usually taken to minimize the digital noise through carefully-designed board layouts, shielding and other digital signal integrity resources, some clock inevitably leaks into the analog signal, producing spurs. Such digital switching noise normally occurs at harmonics of the fixed clock frequency. As a result, periodic clock signals and power supply spurs occurring at multiples of the clock frequency are often the most problematic.

In addition to the careful board design typically employed to minimize the digital noise, some manufacturers of integrated circuit devices use spread spectrum clocking to reduce spurs. Spread spectrum clocking ramps the system clock up and down a few percent in frequency to spread out the clock spurs. However, this approach involves some complexity in the initial clock source design. In addition, precision analog instrumentation is usually not able to tolerate the additional phase noise introduced into the system by the spread spectrum clocking. Therefore, what is needed is a spur reduction technique for a mixed-signal system.

### SUMMARY OF THE INVENTION

Embodiments of the present invention provide a mixed-signal system capable of reducing spurious signals in data signals by estimating the amplitude and phase of a spur cancellation signal. The mixed-signal system includes a processor connected to receive a converted test signal including one or more spurious signals. The converted test signal corresponds to an analog or digital test signal converted between the analog domain and the digital domain. The processor estimates the amplitude and phase of the spur cancellation signal from the converted test signal. The spur cancellation signal can be used to reduce the one or more spurious signals in a data signal.

For example, in one embodiment, the test signal includes two or more test signals, each having an amplitude equal to the amplitude of the spur cancellation signal. The processor estimates the phase of the spur cancellation signal by iteratively converging the phase of said two or more test signals. In another embodiment, the test signal is a combined test signal of the spurious signal and another signal having an amplitude equal to the amplitude of the spur cancellation signal with a phase angle of zero. The processor estimates the phase of the spur cancellation signal using triangulation of the combined test signal, the spurious signal and the other signal.

In operation, the mixed-signal system includes a combiner for receiving the data signal including the spurious signal and the spur cancellation signal. The combiner combines the data signal with the spur cancellation signal to reduce the spurious signal in the data signal and produce a combined data signal. In one embodiment, the combiner is included within a multiplexer/demultiplexer that multiplexes/demultiplexes the data signal from a first rate to a second rate and provides the multiplexed data signal to the combiner. In another embodiment, the combined data signal is stored in a memory and provided to the multiplexer/demultiplexer.

In a further embodiment, the data signal includes randomized data to provide a substantially uniform number of data transitions during a predetermined time interval. In one exemplary embodiment, the mixed-signal system includes a pseudorandom generator for generating a pseudorandom pattern, a logic device for producing the randomized data using the pseudorandom pattern and original data and a descrambler for derandomizing the data signal at the second rate of the multiplexer. In another exemplary embodiment, the mixed-signal system further includes a memory for storing the randomized data and a pseudorandom pattern and a descrambler for derandomizing the randomized data at the second rate of the multiplexer using the stored pseudorandom pattern.

Embodiments of the present invention further provide a method for reducing spurious signals in a mixed-signal system. The method includes receiving a converted test signal including one or more spurious signals. The converted test signal corresponds to an analog or digital test signal converted between the analog domain and the digital domain. The method further includes estimating an amplitude and phase of a spur cancellation signal from the converted test signal for use in reducing the spurious signal in a data signal.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram illustrating a mixed-signal system capable of producing spurs;

FIG. 2 is a diagram illustrating spur frequencies in a mixed-signal system;

FIG. 3 is a block diagram illustrating an exemplary spur detector for estimating a spur cancellation signal, in accordance with embodiments of the present invention;

FIG. 4A is a flow chart illustrating an exemplary process for estimating the amplitude and phase of the spur cancellation signal using iterative estimation, in accordance with embodiments of the present invention;

FIG. 4B is a flow chart illustrating another exemplary process for estimating the amplitude and phase of the spur cancellation signal using triangulation spur estimation, in accordance with embodiments of the present invention;

FIG. 5 is a diagram illustrating triangulation spur estimation, in accordance with embodiments of the present invention;

FIG. 6 is a flow chart illustrating another exemplary process for estimating the amplitude and phase of the spur cancellation signal using an FFT of digital data, in accordance with embodiments of the present invention;

FIG. 7 is a block diagram illustrating an exemplary mixed-signal system including a digital-to-analog converter (DAC) for reducing spurious signals using the spur cancellation signal of FIG. 3, in accordance with embodiments of the present invention;

FIG. 8 is a block diagram illustrating an exemplary mixed-signal system including an analog-to-digital converter (ADC) for reducing spurious signals using the spur cancellation signal of FIG. 3, in accordance with embodiments of the present invention;

FIG. 9 is a block diagram illustrating an exemplary mixed-signal system for reducing spurious signals using data randomization, in accordance with embodiments of the present invention;

FIG. 10 is a block diagram of another exemplary mixed-signal system for reducing spurious signals using data randomization; and

FIG. 11 is a flow chart illustrating an exemplary process for reducing spurious signals in mixed-signal system, in accordance with embodiments of the present invention.

### DETAILED DESCRIPTION OF THE EXEMPLARY EMBODIMENTS

As used herein, the term “data multiplexer” refers to both multiplexers used in DAC mixed-signal systems and demulitplexers used in ADC mixed-signal systems. In addition, as used herein, the terms “data signal” and “test signal” may refer to one or both of analog signals and digital signals.

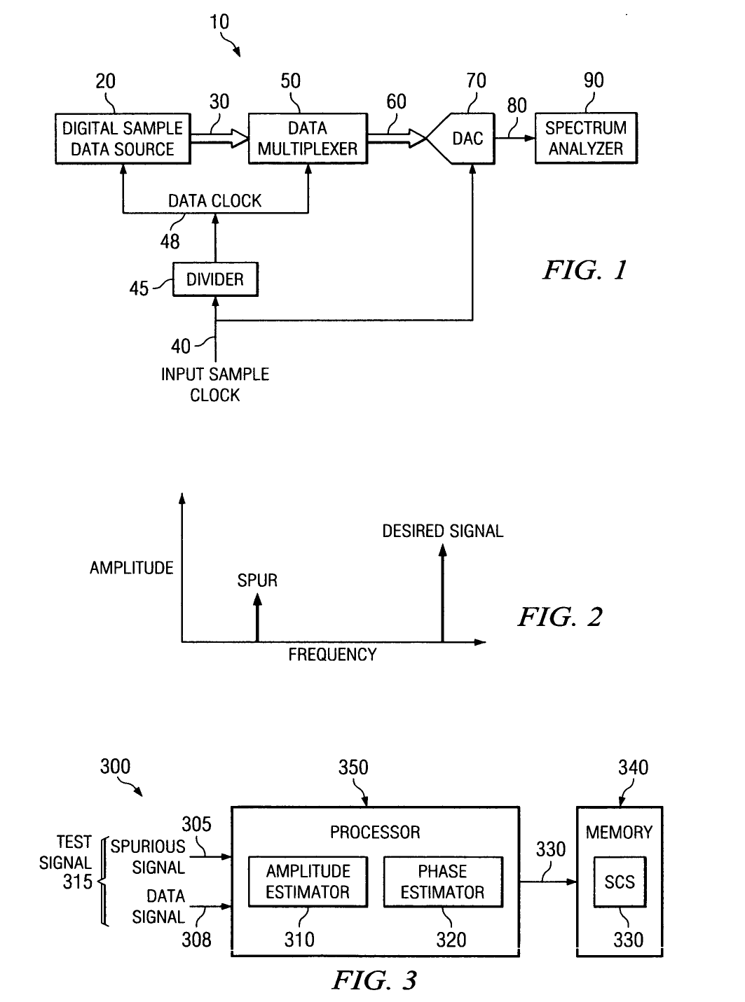

FIG. 1 is a block diagram illustrating a mixed-signal system 10 capable of producing spurs. The mixed-signal system 10 includes a digital sample data source 20, a data multiplexer 50 and a high-speed digital-to-analog converter (DAC) 70. The digital sample data source 20 (e.g., an arbitrary waveform generator or ARB module) generates a fixed digital pattern (digital data signal 30) that describes a sinusoidal tone. The digital sample data source 20 is clocked by a data clock 48 produced by dividing an input sample clock 40 through divider 45 to read digital data from an internal memory at a submultiple of the sampling rate of the sample clock 40. The digital sample source 20 outputs the digital data signal 30 to the data multiplexer 50 at the rate of the data clock 48. The data source 20 provides several successive samples in parallel on each cycle of the data clock 48.

The data multiplexer 50 multiplexes the parallel digital data signal 30 from the data clock rate 48 back up to the original sample clock rate 40 to drive the high-speed DAC 70. In FIG. 1, the data multiplexer 50 provides the multiplexed digital data signal 60 to the DAC 70, which converts the multiplexed digital data signal 60 from a digital signal to an analog signal 80. Digital clock noise from the digital circuitry may cause a spur on the analog output 80 of the DAC 70. For example, the data clock 48 from divider 45 may have a frequency of 125 MHz, and the high-speed DAC 70 may have a 1 GS/s output sample rate, set by the input sample clock 40. In this example, spurs at the clock frequency of 125 MHz and harmonics thereof are possible due to the large amount of digital logic clocking at the lower data clock rate of 125 MHz.

The resulting spectrum as viewed on a spectrum analyzer 90 would be similar to the frequency diagram shown in FIG. 2. As can be seen in FIG. 2, both the desired signal and the spurious signal appear on the spectrum analyzer 90. The spectrum analyzer 90 is capable of measuring both the spur frequency of each spur in the analog output signal 80 and the amplitude thereof. However, the phase of each spur in the analog output signal 80 is unknown, and therefore, spurious signals cannot be effectively characterized or minimized using the spectrum analyzer 90.

Although the spur amplitude is usually significantly less than the desired signal amplitude, such spurs may be undesirable in many applications. However, since clock feed-through is largely determined by geometric effects, such as cross-talk and radiated emissions, clock feed-through is relatively stable at the low (not microwave) frequencies of ADC and DAC mixed-signal systems. As a result, in accordance with embodiments of the present invention, the spurs produced by mixed-signal systems due to clock feed-through can be characterized and minimized.

FIG. 3 is a block diagram illustrating an exemplary spur detector 300 for estimating a spur cancellation signal 330, in accordance with embodiments of the present invention. The spur detector 300 includes a processor 350 and memory 340. The processor 350 is coupled to receive a test signal, labeled 315, from the mixed-signal system (e.g., the DAC system 10 shown in FIG. 1 or an ADC system). The test signal 315 includes both a spurious signal 305 and a data signal 308. For example, in a DAC mixed-signal system, such as the system 10 shown in FIG. 1, the data signal 308 corresponds to the analog output signal 80 (including spurs), and the spurious signal 305 corresponds to an added signal (added to the digital data signal 30) at one of the spur frequencies, as measured by the spectrum analyzer. As another example, in an ADC mixed-signal system, the data signal 308 corresponds to digital data generated by the ADC in response to receipt of an analog input signal, and the spurious signal 305 corresponds to one of the spurs in the digital data output by the ADC.

The processor 350 is operable to identify a spur cancellation signal 330 that can be used to reduce or eliminate the spur corresponding to the spurious signal 305 frequency in a subsequent data signal output by the mixed-signal system. The processor 350 includes an amplitude estimator 310 for estimating the amplitude of a spur cancellation signal 330 and a phase estimator 320 for estimating the phase of the spur cancellation signal 330. The amplitude estimator 310 measures the amplitude of the spurious signal 305 and sets the amplitude of the spur cancellation signal 330 to the measured amplitude of the spurious signal 305. The phase estimator 320 estimates the phase of the spur cancellation signal 330 using the data signal 308 and the test signal 315.

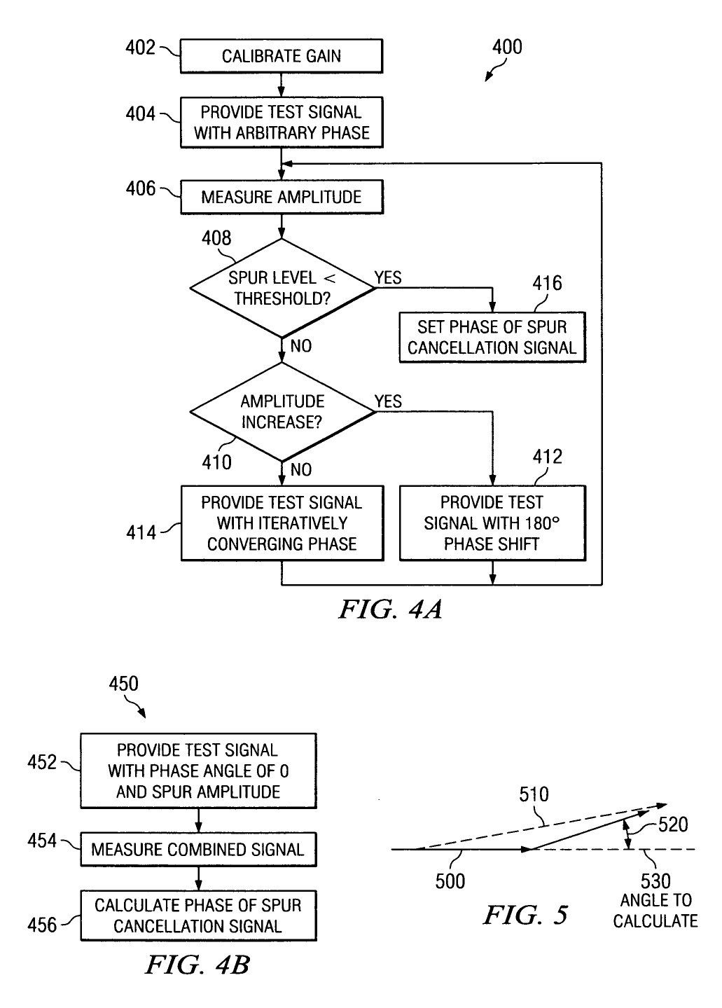

For example, in embodiments in which the mixed-signal system is a DAC mixed-signal system, the phase estimator 310 uses either an iterative process or a triangulation process to estimate the phase of the spur cancellation signal 330. The iterative process is described in more detail below in connection with FIG. 4A, and the triangulation process is described in more detail below in connection with FIG. 4B. As another example, in embodiments in which the mixed-signal system is an ADC mixed-signal system, the phase estimator 320 takes a fast Fourier transform (FFT) of the digital data and windows out the desired data signal in the FFT to produce a residual signal containing the spurious signal 305. The phase estimator 310 further takes an inverse FFT to determine the time domain response of the spur, and uses the time domain response of the spur to determine the phase of the spur cancellation signal 330. The FFT process is described in more detail below in connection with FIG. 5.

The processor 350 stores the frequency, amplitude and phase of the spur cancellation signal 330 in the memory 340 for subsequent use in reducing the spur associated with the spur cancellation signal 330 in a new data signal. The processor 350 can be a microprocessor, microcontroller, programmable logic device or any other processing device. The memory 340 can be any type of memory device, such as, for example, a flash ROM, EEPROM, ROM, RAM or any other type of storage device. In one embodiment, the memory device 340 also stores software (not shown) executable by the processor 350 to measure the amplitude and estimate the phase of the spur cancellation signal 330. In another embodiment, the algorithm for determining the spur cancellation signal 330 is stored in the processor 350, and the memory device 340 also stores data used by the processor 350 during the spur cancellation signal estimation process.

The processor 350 may be implemented entirely within the mixed-signal system, partially within the mixed-signal system or externally to the mixed-signal system. For example, in a DAC mixed-signal system (such as the system 10 shown in FIG. 1), the processor 350 may be at least partially implemented within the spectrum analyzer 90 to measure the amplitude and frequency of the spurious signal 305. As another example, in an ADC mixed-signal system, the processor 350 may be at least partially implemented within the mixed-signal system to process the digital data stored within the mixed-signal system.

FIG. 4A is a flow chart illustrating an exemplary process 400 for estimating the amplitude and phase of the spur cancellation signal using iterative estimation, in accordance with embodiments of the present invention. Processing begins at block 402 where a small test signal of known amplitude near the frequency of the spur is added and measured with a spectrum analyzer to calibrate the gain of the test equipment (e.g., the spectrum analyzer and other processing devices). At block 404, a first spurious signal at the spur frequency having an amplitude equal to the spur cancellation signal and an arbitrary phase is added to the digital data signal input to the DAC and the combined test signal is input to the DAC. At block 406, the amplitude of the spur in the analog output signal from the DAC is measured with the spectrum analyzer.

At block 408, the measured spur amplitude is compared to a threshold set to ensure a low spur level. If the measured spur amplitude is greater than the threshold, the processing continues at block 410, where a determination is made whether the amplitude of the spur increased from that of the original spur amplitude. If so, the processing continues at block 412, where another spurious signal at the spur frequency having an amplitude equal to the spur cancellation signal and a 180 degree phase-shift from the first spurious signal is added to the digital data signal input to the DAC and the combined test signal is input to the DAC. However, if the amplitude of the spur did not increase, the processing continues at block 414, where another spurious signal at the spur frequency having an amplitude equal to the spur cancellation signal and an iteratively converging phase is added to the digital data signal input to the DAC and the combined test signal is input to the DAC. The iteration is continued until the spur level is less than the threshold at bloc 408. Once the spur level is sufficiently low, processing continues at block 416, where the phase of the spur cancellation signal is set to the phase of the most recent spurious signal added to the digital data signal.

For example, the phases (P) set for the spurious signal in the iteratively converging process at block 414 as follows:
P0=P0
P1=P0+180 degrees
P2=P1+90 degrees
P3=P2+45 degrees
PN=P (N−1)+(180/2ˆ(N−1))

FIG. 4B is a flow chart illustrating another exemplary process 450 for estimating the amplitude and phase of the spur cancellation signal using triangulation spur estimation, in accordance with embodiments of the present invention. Processing begins at block 452 where a small test signal of the same amplitude as the spur to be canceled and a phase angle of 0 is added to the digital data signal input to the DAC and the combined test signal is input to the DAC. At block 454, the amplitude of the combined test signal is measured and at block 456, the phase of the spur is calculated using the law of cosines. The phase of the spur cancellation signal is set as 180 degrees different than that of the spur phase.

For example, as shown in FIG. 5, the combined test signal is represented by dotted vector 510, the test signal with a phase angle of 0 is represented by the dark solid vector 500 and the unknown spur is represented by the light solid vector 520. The unknown angle 530, representing the phase of the unknown spur 520 is calculated using the law of cosines. For example, assuming for simplicity that the magnitudes (amplitudes) are normalized to unity, then by the law of cosines, the angle (P) of the unknown vector 520 relative to the dashed line (i.e., 0 angle line corresponding to the test signal vector 500) is:
P=π−arcos((2−c²)/2),
Where c is the length of the combined vector 510 (i.e., the magnitude of the combined test signal measured on the spectrum analyzer).

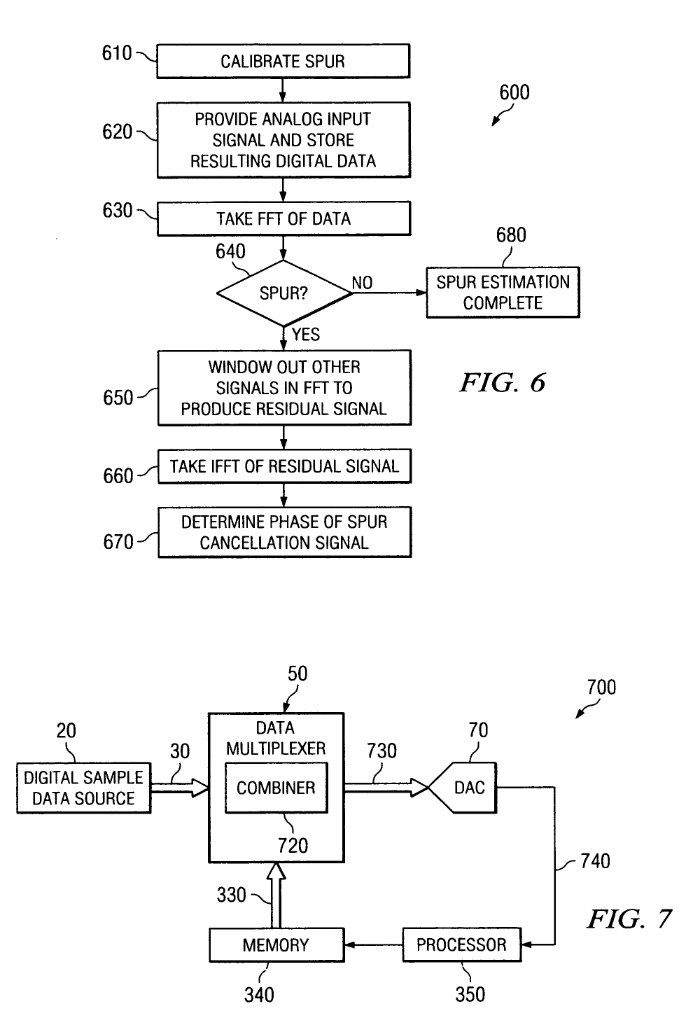

FIG. 6 is a flow chart illustrating another exemplary process 600 for estimating the amplitude and phase of the spur cancellation signal using an FFT of digital data, in accordance with embodiments of the present invention. Processing begins at block 610, where the spur is calibrated by feeding a continuous wave tone that is “spur-free” at the data clock rate into the analog input of the mixed-signal system. At block 620, an analog signal is applied to the analog input of the mixed-signal system and the resulting digital data is stored in a memory. Processing then continues at block 630, where a fast Fourier transform (FFT) of the digital data is taken to observe the frequency characteristics of the digital data. If a spur is present at block 640, processing continues at block 650, where the desired signal and any signals other than the current spurious signal are digitally filtered out of the data by windowing out these signals in the FFT to produce a residual signal containing the spurious signal. At block 660, an inverse FFT of the residual signal is taken to determine the time domain response of the spur, and at block 670, the time domain response of the spur is used to determine the phase of the spur cancellation signal. This process is repeated at block 640 for each spur present in the digital data until all spur cancellation signals have been estimated at block 680.

FIG. 7 is a block diagram illustrating an exemplary DAC mixed-signal system 700 for reducing spurious signals using the spur cancellation signal 330 of FIG. 3, in accordance with embodiments of the present invention. The mixed-signal system 700 includes the digital sample data source 20, the data multiplexer 50, a combiner 720, the DAC 70 and the memory 340 storing the spur cancellation signal(s) 330. Although the processor 350 of FIG. 3 is also shown in the mixed-signal system 700, in other embodiments, the processor 350 is separate from the mixed-signal system 700. In addition, in other embodiments, the mixed-signal system 700 includes only the processor 350, which provides the spur-cancellation signal(s) 330 to another mixed-signal system. Furthermore, although the combiner 720 is shown within the data multiplexer 50, in other embodiments, the combiner 720 is separate from the data multiplexer 50.

In operation, the digital sample data source 20 provides the digital data signal 30 to the data multiplexer 50 at the sampling rate data clock. The data multiplexer 50 multiplexes the digital data signal 30 from the sampling rate of the data clock up to a higher sample clock rate to drive the high-speed DAC 70 and provides the multiplexed data to the combiner 720. The combiner 720 accesses the memory 340 to retrieve one or more spur cancellation signals 330 and combines the spur cancellation signals 330 with the multiplexed data to substantially cancel any spurious signals in the multiplexed data. The output of the combiner 720 is a combined data signal 730 with reduced spurs. The combined data signal 730 is input to the DAC 70, which converts the combined data signal 730 from a digital signal to an analog signal 740.

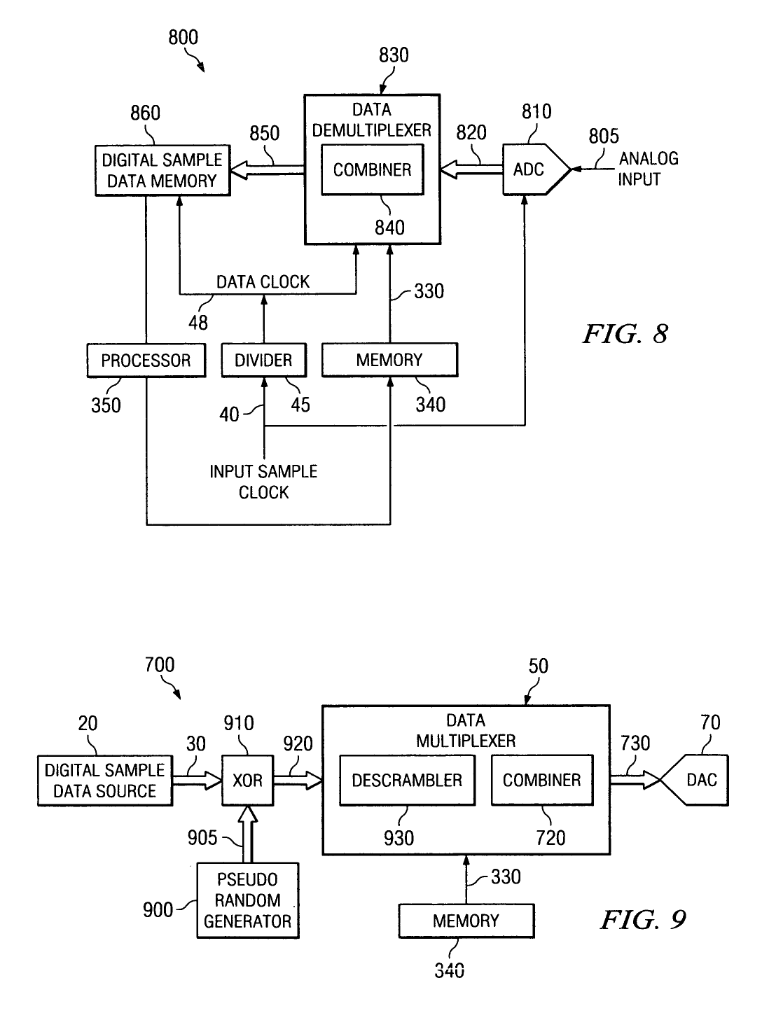

FIG. 8 is a block diagram illustrating an exemplary ADC mixed-signal system 800 for reducing spurious signals using the spur cancellation signal of FIG. 3, in accordance with embodiments of the present invention. The ADC mixed-signal system 800 includes an analog-to-digital converter 810, a data demultiplexer 830, a combiner 840 a digital sample data memory 860 and the memory 340 storing the spur cancellation signal(s) 330. Although the processor 350 of FIG. 3 is also shown in the mixed-signal system 800, in other embodiments, the processor 350 is separate from the mixed-signal system 800. In addition, although the combiner 840 is shown within the data demultiplexer 830, in other embodiments, the combiner 840 is separate from the data demultiplexer 830. Furthermore, in other embodiments, memory 340 can be included within digital sample data memory 860.

In operation, an analog signal 805 is provided to the analog input of the mixed-signal system 800 and received at the ADC 810 converts the analog input signal from the analog domain to the digital domain to produce digital data signal 820. The digital data signal 820 is input to the data demultiplexer 830 which demultiplexes the digital data signal 820 from the sampling rate of the ADC 810 down to a lower sampling rate of the data clock 48, and provides the deserialized data to the combiner 840. The combiner 840 accesses the memory 340 to retrieve one or more spur cancellation signals 330 and combines the spur cancellation signals 330 with the demultiplexed data to substantially cancel any spurious signals in the demultiplexed data. The output of the combiner 840 is a combined data signal 850 with reduced spurs. The combined data signal 850 is stored in the digital sample data memory 860.

FIG. 9 is a block diagram illustrating an exemplary mixed-signal system for reducing spurious signals using data randomization, in accordance with embodiments of the present invention. In order to ensure a constant level of spurious energy independent of the contents of the waveform memory, data randomization can be employed to provide a nearly uniform number of data transitions (transitions between 0 and 1) on the digital lines during any predetermined time interval. In most synchronous logic types (such as CMOS) that are used for memory devices, each data transition results in a small current draw at the transition of the synchronous clock. By having a uniform number of transitions during any time interval, the synchronous current draw (and the corresponding perturbation of the ground planes which gives rise to the spur) is constant. Thus, the spur can be canceled independent of the data pattern stored in the memory. Without randomization, certain pattern types (e.g., an all 0's pattern) will have less spurious energy than other patterns with a high digital transition density (e.g., a 0, 1, 0, 1 pattern).

As shown in FIG. 9, randomization is achieved by exclusively ORing (XOR 910) the data 30 provided by the digital sample data source 20 with a pseudorandom pattern 905 generated by a pseudorandom generator 900 to produce a randomized data 920. For example, the pseudorandom generator 900 can include one or more linear feedback shift registers to produce the pseudorandom pattern 905. The seed value of the pseudorandom pattern can be obtained from the address of the memory block being accessed by the digital sample data source 20.

The randomized data 920 is input to the data multiplexer 50 to multiplex the randomized data 920 from the sampling rate of the data clock up to a higher serial sample rate of the high-speed DAC 70. The randomized data is provided to a descrambler 930 within the data multiplexer 50 to derandomize the data prior to combining the derandomized data with the one or more spur cancellation signals 330 in the combiner 720. Again, the combiner 720 accesses the memory 340 to retrieve one or more spur cancellation signals 330 and combines the spur cancellation signals 330 with the derandomized and multiplexed data to substantially cancel any spurious signals in the data. The output of the combiner 720 is the combined data signal 730 with reduced spurs. The combined data signal 730 is input to the DAC 70, which converts the combined data signal 730 from a digital signal to an analog signal.

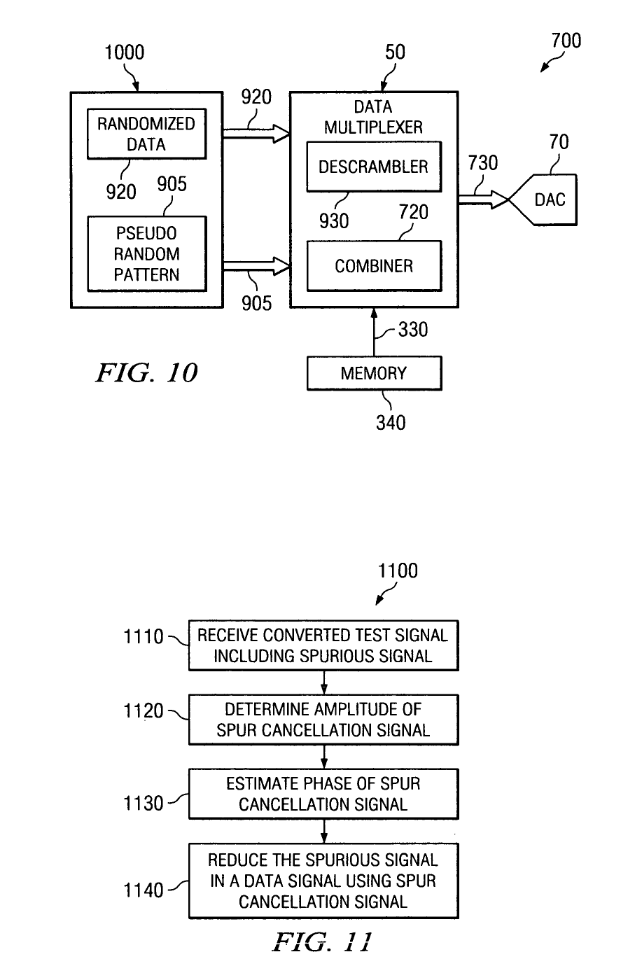

FIG. 10 is a block diagram of another exemplary mixed-signal system for reducing spurious signals using data randomization. Instead of randomizing the data at the input to the data multiplexer 50, in other embodiment, randomization can be achieved by XORing the pseudorandom pattern 905 in a memory 1000. The randomized data 920 is input to the data multiplexer 50 to multiplex the randomized data 920 from the data clock rate up to the higher sample clock rate that drives the high-speed DAC 70. The multiplexed and randomized data and the pseudorandom pattern are provided to a descrambler 930 within the data multiplexer 50 to derandomize the data prior to combining the derandomized data with the one or more spur cancellation signals 330 in the combiner 720, as discussed above in connection with FIG. 9.

FIG. 11 is a flow chart illustrating an exemplary process 1100 for reducing spurious signals in mixed-signal system, in accordance with embodiments of the present invention. The processing begins at block 1110, where a converted test signal including one or more spurs is received. The converted test signal corresponds to a test signal converted between an analog domain and a digital domain. For example, in a DAC mixed-signal system, the converted test signal can is a combination of an analog output signal including spurs and an added spurious signal 305 at one of the spur frequencies. As another example, in an ADC mixed-signal system, the converted test signal is digital data generated by the ADC in response to receipt of an analog input signal, in which the digital data includes one or more spurious signals.

The processing continues at block 1120, where an amplitude of a spur cancellation signal for one of the spurs is determined. For example, in a DAC mixed-signal system, the amplitude of the spur cancellation signal can be determined using a spectrum analyzer, and the spurious signal added to the converted test signal can be a signal at the spur frequency and spur amplitude. As another example, in an ADC mixed-signal system, the amplitude of the spur cancellation signal can be determined using the FFT of the stored digital data.

Thereafter, at block 1130, the phase of the spur cancellation signal is estimated, using, for example, the iterative process shown in FIG. 4A, the triangulation process shown in FIG. 4B or the FFT process shown in FIG. 6. Once the amplitude and phase of the spur cancellation signal are determined, processing continues at block 1140, where the spur cancellation signal is applied to subsequent data signals to reduce the spurious signal associated with the spur cancellation signal in the data signal.

The spur cancellation technique described herein can be used to cancel any type of spurious signal. For example, if a trigger signal at the 60 Hz power supply rate is generated using a simple comparator, the spur cancellation technique described above can be applied to the power supply spurs. In this case, changes in circuit grounding may cause the spur level to vary between boards. In addition, changes in temperature may also cause the spur level to vary between boards depending on the grounding of the test equipment (e.g., spectrum analyzer).

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

I claim:

1. A mixed-signal system for reducing spurious signals, said mixed-signal system comprising:
a processor connected to receive a converted test signal, said converted test signal corresponding to a test signal converted between an analog domain and a digital domain, said converted test signal including a spurious signal; and
wherein said processor is operable to determine an amplitude of a spur cancellation signal in association with said converted test signal and to estimate a phase of a spur cancellation signal from said converted test signal for use in reducing said spurious signal in a data signal.

2. The system of claim 1, wherein said test signal is a digital pattern and additionally comprising a digital-to-analog converter operable to produce said converted test signal.

3. The system of claim 1, wherein said test signal is an analog signal and additionally comprising an analog-to-digital converter operable to produce said converted test signal.

4. The system of claim 1, additionally comprising a combiner connected to receive said data signal including said spurious signal and said spur cancellation signal, and wherein said combiner is operable to combine said data signal with said spur cancellation signal to reduce said spurious signal in said data signal and produce a combined data signal.

5. The system of claim 4, additionally comprising a multiplexer connected to receive said data signal at a first rate and multiplex said data signal to a second rate.

6. The system of claim 5, wherein said first rate is lower than said second rate, and wherein said multiplexer is operable to read data forming said data signal at said first rate and multiplex said data signal up to said second rate.

7. The system of claim 5, wherein said first rate is higher than said second rate, and wherein said multiplexer is operable to receive said data signal at said first rate and demultiplex said data signal down to said second rate.

8. The system of claim 5, wherein said combiner is connected to receive said data signal at said second rate.

9. The system of claim 5, wherein said combiner is within said multiplexer.

10. The system of claim 5, additionally comprising a memory for storing data representing said data signal, and wherein said combiner is connected to receive said data to produce said combined data signal.

11. The system of claim 5, additionally comprising a memory for storing said combined data signal and providing said combined data signal to said multiplexer.

12. The system of claim 5, wherein said data signal includes randomized data to provide a substantially uniform number of data transitions during a predetermined time interval.

13. The system of claim 12, additionally comprising a pseudorandom generator for generating a pseudorandom pattern, a logic device operable to produce said randomized data using said pseudorandom pattern and a descrambler operable to derandomize said data signal at said second rate.

14. The system of claim 12, additionally comprising a memory for storing said randomized data and a pseudorandom pattern and a descrambler operable to derandomize said randomized data at said second rate using said pseudorandom pattern.

15. The system of claim 1, wherein said spurious signal includes two or more spur frequencies at harmonics of a clock frequency of said system.

16. The system of claim 1, wherein said test signal includes two or more test signals, each having an amplitude equal to said amplitude of said spur cancellation signal, and wherein said processor is operable to estimate said phase of said spur cancellation signal by iteratively converging the phase of said two or more test signals.

17. The system of claim 1, wherein said test signal is a combined test signal of said spurious signal with a first signal having an amplitude equal to said amplitude of said spur cancellation signal and a phase angle of zero, and wherein said processor is operable to estimate said phase of said spur cancellation signal using triangulation of said first signal, said spurious signal and said combined test signal.

18. A method for reducing spurious signals in a mixed-signal system, said method comprising:
receiving a converted test signal, said converted test signal corresponding to a test signal converted between an analog domain and a digital domain, said converted test signal including a spurious signal;
determining an amplitude of a spur cancellation signal in association with said converted test signal; and
estimating a phase of said spur cancellation signal from said converted test signal for use in reducing said spurious signal in a data signal.

19. The method of claim 18, additionally comprising:
receiving said data signal including said spurious signal and said spur cancellation signal; and
combining said data signal with said spur cancellation signal to reduce said spurious signal in said data signal and produce a combined data signal.

20. The method of claim 19, wherein said receiving said data signal additionally comprises:
storing data representing said data signal; and
receiving said data to produce said combined data signal.

21. The method of claim 19, wherein said receiving said data signal additionally comprises:
receiving said data signal at a first rate; and
multiplexing said data signal to a second rate.

22. The method of claim 21, wherein said multiplexing said data signal additionally comprises:
storing said combined data signal; and
multiplexing said combined data signal from said first rate to said second rate.

23. The method of claim 21, wherein said data signal includes randomized data to provide a substantially uniform number of data transitions during a predetermined time interval.

24. The method of claim 23, additionally comprising:
generating a pseudorandom pattern;
producing said randomized data using said pseudorandom pattern; and
derandomizing said data signal at said second rate.

25. The method of claim 23, additionally comprising:
storing said randomized data and a pseudorandom pattern; and
derandomizing said data at said second rate using said pseudorandom pattern.

26. The method of claim 18, wherein said test signal includes two or more test signals, each having an amplitude equal to an amplitude of said spur cancellation signal, and wherein said estimating additionally comprises:
estimating a phase of said spur cancellation signal by iteratively converging the phase of said two or more test signals.

27. The method of claim 18, wherein said test signal is a combined test signal of said spurious signal and a first signal having an amplitude equal to an amplitude of said spur cancellation signal with a phase angle of zero, and wherein said estimating additionally comprises:
estimating a phase of said spur cancellation signal using triangulation of said first signal, said spurious signal and said combined test signal.
